(19) United States
(12) Patent Application Publication
(10) Pub. No.: US 2011/0009086 A1
(43) Pub. Date: Jan. 13, 2011

(54) Text to 9-1-1 emergency communication

(76) Inventors: Todd Poremba, Seattle, WA (US); Richard Dickinson, Seattle, WA (US); Firdaus Aryana, Seattle, WA (US)

Correspondence Address: MANELLI DENISON & SELTER PLLC, 2000 M Street, N.W., 7th Floor, Washington, DC, 20036-3307, US

(21) Appl. No.: 12/801,036

(22) Filed: May 18, 2010

Related U.S. Application Data
(60) Provisional application No. 61/213,758, filed on Jul. 10, 2009.

(51) Int. Cl. H04M 11/04

(52) U.S. Cl. 455/404.1

(57) ABSTRACT

A text messaging caller is enabled to communicate with a called party situated at on voice network, such as a PSTN or emergency 911 service center. The method comprises providing a service center, pre-registering a caller with the service center, receiving a text message from the caller through the service center, converting the text message to a voice message, ascertaining the address of the caller according to pre-registration information, and sending the voice message to the called party on the voice network together with the caller's identification and location information.

This application claims priority from U.S. Provisional Application No. 61/213,758, entitled “Text To 9-1-1 Communication System and Method”, filed on Jul. 10, 2009, the entirety of which is expressly incorporated herein by reference.

### BACKGROUND OF THE INVENTION

1. Field of the Invention

This invention relates to communication systems and methods. More specifically, the invention concerns a multi-modal text communication system for accessing a conventional public safety phone network or a 9-1-1 Emergency Services Telephone Network.

2. Background of the Related Art

To provide flexibility for 9-1-1 callers to obtain emergency services, it is desirable to enable communication with a wide variety of wired and wireless devices. Many people erroneously believe that they can reliably send an emergency text message to a 9-1-1 Public Safety Answering Points (PSAP) using a hand held PDA, such as a Blackberry, an iPhone, or even a laptop computer. The hearing-impaired is especially desirous of a means of communicating with a PSAP via text messaging.

But conventional 9-1-1 PSAP infrastructure is designed for voice traffic and is not capable of passing data other than telephone numbers or dial tones across legacy switching routers or CAMA trunks. Trials have been attempted in which text messaging is transmitted to PSAPs using Internet Protocol (IP) infrastructure, but such trials replace or circumvent legacy infrastructure, which delays and renders a nationwide, dependable implementation much more costly. To accomplish this capability nationwide 9-1-1 emergency systems would need to replace legacy infrastructure with an Internet Protocol (IP) backbone, to upgrade PSAP equipment, not to mention the need for every service provider to participate and actively provision each potential user, etc. There is a need for a ubiquitous solution for text communications with PSAPs.

### SUMMARY OF THE INVENTION

In accordance with the principles of the present invention, a text-to-911 communication system enabling a text messaging caller to communicate with a called party on an emergency services voice network comprises a physical communication server adapted to receive an emergency text message from an emergency text messaging caller. A text-to-speech translator converts the emergency text message to converted voice. A physical emergency services gateway is adapted to pass the converted voice to a called party on a 911 emergency services voice network.

In another aspect, a method of enabling an emergency text messaging caller to communicate with a called party on an emergency services network comprises receiving an emergency text message from an emergency text messaging caller. A street address of the emergency text messaging caller is obtained from a database including pre-registered location information relating to the caller. The received emergency text message is converted to an emergency converted voice message. The emergency converted voice message is routed to the called party, the emergency converted voice message including the obtained pre-registered location information relating to the emergency text messaging caller.

In yet another aspect of the invention, a method of enabling an emergency text messaging caller to communicate with a called party situated on an emergency services network comprises providing in physical memory a set of pre-programmed voice responses. The emergency text messaging caller is prompted to select at least one of the pre-programmed voice responses. A location of the emergency text messaging caller is obtained from a database including pre-registered location information relating to the caller. The emergency converted voice message is routed to the called party, with the emergency converted voice message including the obtained pre-registered location information relating to the emergency text messaging caller.

### BRIEF DESCRIPTION OF THE DRAWINGS

Features and advantages of the present invention will become apparent to those skilled in the art from the following description with reference to the drawings, in which:

FIG. 1 shows a trace of an emergency 9-1-1 text message sent from a text-capable device within an existing wireless system, in accordance with the principles of the present invention.

FIG. 2 shows an emergency 9-1-1 text messaging system that additionally includes a voice player wherein like reference numerals of other components in the system indicate components similar to the system shown in FIG. 1, in accordance with another aspect of the present invention.

FIG. 3 shows an emergency 9-1-1 text messaging system wherein like reference numerals of other components in the system correspond to elements of the system shown in FIG. 1, but additionally including a text-speech translation device, in accordance with yet another aspect of the invention.

FIG. 4 shows a text-to-911 messaging system similar to the system of FIG. 1 but additionally including an interactive voice response (IVR) system and a text-speech translation device in accordance with another aspect of the present invention.

FIG. 5 shows a VPC 9-1-1 text relay system situated at a network operations center to provide automatic call routing, automatic location data, automatic IM/SMS address, and optional DTMF pre-programmed responses created by user customization in accordance with another aspect of the present invention.

### DETAILED DESCRIPTION OF ILLUSTRATIVE EMBODIMENTS

The present invention enables both Short Message Service (SMS) and Instant Messaging (IM) communication to be routed to a correct PSAP together with the caller's location information using existing legacy telephone networks.

The present invention also allows two-way communication with an emergency services dispatcher situated at a PSAP who may, based on information obtained through interrogation or otherwise, dispatch the appropriate services according to the user's location and the nature of the emergency.

One aspect of the invention achieves such two-way text to 9-1-1 communication by treating text-based technologies similar to VoIP technologies for succession of the message through the Publicly Switched Telephone Networks (PSTN).

This invention solves the problem of multiple IM and SMS protocols lacking a single method to communicate with existing 9-1-1 systems.

This invention further provides in-band communication using text-to-speech and speech-to-text conversion. The invention also solves prior art drawbacks by employing text-to-speech and IVR-controlled text responses.

This invention also allows for IM and SMS to TTY conversion in legacy emergency networks.

Advantageously, the present invention facilitates text communications between a caller and a local PSAP without requiring replacement of legacy infrastructure.

The inventors have realized that during periods of mass emergency, the SMS system tends to be largely available at times when the voice-based systems are not. To leverage this ability, the present invention enables subscribers to pre-register appropriate emergency contact information in an emergency SMS registration database accessible by an emergency SMS server. Thereafter, making use of such provisioning and an emergency SMS server, enables subscribers to send an emergency 9-1-1 text message to virtually any PSAP currently existing in the United States.

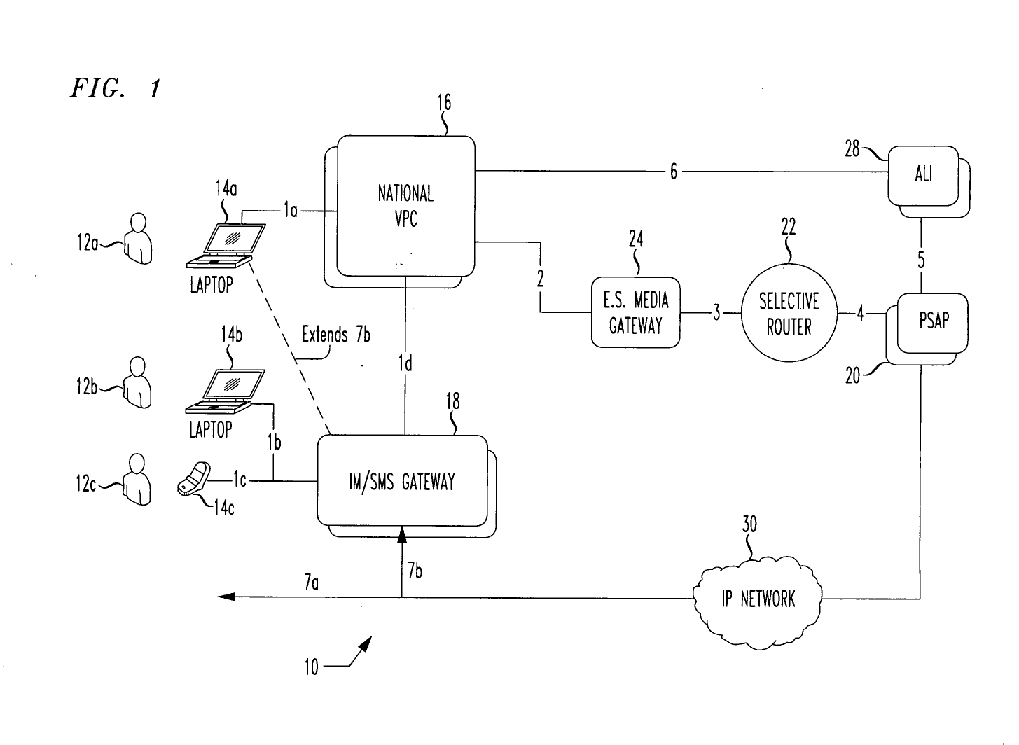

FIG. 1 shows a trace of an emergency 9-1-1 text message sent from a text-capable device within an existing wireless system 10, in accordance with the principles of the present invention.

In particular, as shown in FIG. 1, an emergency 9-1-1 text message (SMS or IM) is routed via an IP network such as the Internet 30 to a serving IM/SMS gateway 18. The IM/SMS gateway 18 routes the emergency 9-1-1 text message to an appropriate National emergency voice positioning center (VPC) 16.

Importantly, the national emergency VPC 16 routes the received emergency 9-1-1 text message to an emergency services media gateway 24 serving the desired PSAP 20. As shown, the emergency services media gateway 24 accesses the PSAP 20 via its selective router 22. The PSAP 20 accesses the Automatic Location Identifier (ALI) 28 and obtains location and other relevant information relating to the emergency 9-1-1 text message in an otherwise conventional manner.

The emergency services media gateway 24 converts the text payload of the emergency 9-1-1 emergency text message into a suitable form for routing via the selective router 22, e.g., conversion from text-to-speech. Thus, the emergency services media gateway 24 converts the emergency SMS text message to voice utilizing otherwise conventional text-to-speech conversion technology.

To provide a return path to the emergency text messaging device and thus two-way communications, packets of voice data from the PSAP 20 in the emergency service network may be converted by the emergency services media gateway 24 into a text message compatible with the IM or SMS caller's device.

As an alternative to provide a return communication path from the PSAP 20 back to the originating emergency 9-1-1 text messaging device, pre-programmed messages may be selected for sending back to the emergency texting device. The pre-programmed messages may be selected by the emergency operator, e.g., via a user code, button press, or even by automation such as an “message receipt acknowledged” type response to each received emergency 9-1-1 text message.

Prior to placement of an emergency 9-1-1 SMS message, the user or subscriber device registers appropriate emergency information with their service provider. The registered emergency information is stored in an appropriate emergency 9-1-1 text message registration database.

One suitable registration method permits a static or nomadic subscriber to register their name, street address, and preferably their short messaging system (SMS) and/or instant messaging (IM) address with a suitable virtual private components (VPC) provider, preferably via a web interface, e.g., using a suitable Internet browser. The VPC provider stores the registered emergency information for reference and use when an emergency 9-1-1 SMS or IM text message is received. The emergency 9-1-1 SMS or IM text message preferably includes location information, or location information relating to the texting device and the emergency 9-1-1 text message is routed to the PSAP. The VPC provider validates the received street address against an address database contained in a 9-1-1 Master Street Address Guide (MSAG), which cross-references the user's address against an installed database of known street addresses.

In another suitable registration method, the static or nomadic subscriber registers their name and text message address (e.g., SMS and/or IM address) with the VPC provider via a suitable web interface via an SMS or IM client device, e.g., a laptop computer, iPhone, PDA, or other portable computing device. The subscriber preferably loads an add-on to the SMS or IM client device that determines and sends the caller's location whenever they initiate an emergency 9-1-1 SMS or IM text message.

Yet another suitable registration method permits a mobile subscriber to registers their name and IM or SMS address with a VPC provider via a web interface. The subscriber preferably loads an add-on to their IM or SMS client device to determine and send their current location whenever they initiate an emergency 9-1-1 SMS or IM text message.

In still another suitable registration method a subscriber provisions a “shortcut” on their portable computing device (such as a personal data assistant (PDA), netbook, etc.) so that an emergency 9-1-1 SMS or IM text message is sent to the VPC provider.

Referring to FIG. 1, a user 12a, 12b, or 12c initiates a text request for emergency services via an emergency 9-1-1 texting device 14a, 14b, or 14c, which may comprise a computing device, laptop, PDA, cell phone, etc. Here, IM client 14a is SIP based; IM client 14b is not SIP based and messages generated there by must be translated before routing can be determined; and SMS client 14c also generates messages that must be translated before routing can be determined. SIP (Simple Internet Protocol) signaling is sent to a VPC for emergency route determination and routing instruction completion via gateway 18. This may include a 10-digit number that determines the location or path of selective router 22 and a 10-digit number that is recognized by the selective router 22 as being properly routed to PSAP 20 as determined by VPC 16.

The VPC 16 forwards emergency routing details via Session Internet Protocol (SIP) protocol to an Emergency Services Media Gateway 24. The emergency services Media Gateway 24 then sends a pANI (in this case, the 10-digit number that is recognized by the selective router 22 as being properly routed to the PSAP 20 as determined by the VPC 16) to the selective router 22. Next, the selective router 22 sends the digits with no voice to the PSAP 20. The PSAP 20 then queries the Automatic Location Identification (ALI) device 28 with the digits. The ALI 28 then queries the VPC 20 and returns the users name, address, and source address of the text message (SMS or even IM), preferably with a warning or caution message to use the relevant text message format (e.g., SMS or IM) only. Thereafter, PSAP 20 establishes the appropriate text messaging connectivity (e.g., SMS) with a dispatcher located at an appropriate emergency service center (i.e., police, medical, fire and rescue, etc.) through the Internet 30. SMS text messaging communication may be directed over the Internet 30 between the emergency initiating devices 14a, 14b or 14c and the PSAP 20, or an SMS (or IM) message may be anchored on the IM/SMS Gateway 18 for communication with the user 12a, 12b or 12c.

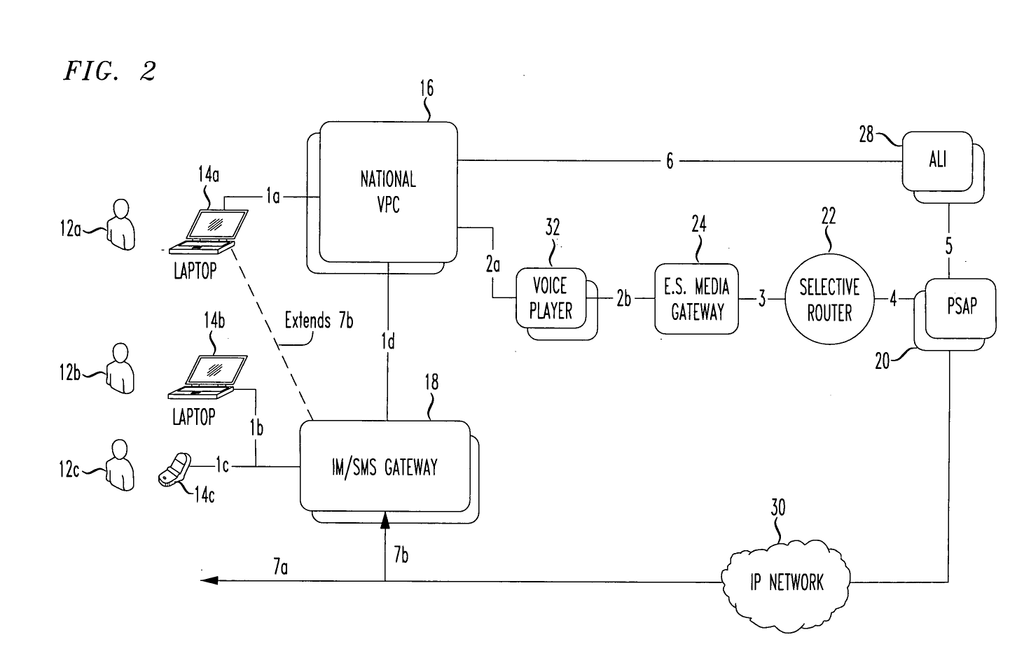

FIG. 2 shows an emergency 9-1-1 text messaging system that additionally includes a voice player 32 wherein like reference numerals of other components in the system indicate components similar to the system shown in FIG. 1.

In particular, as shown in FIG. 2, an emergency texting device 12a, 12b or 12c initiates a text request for emergency services. Various exemplary clients 14a, 14b or 14c may generate the emergency 9-1-1 text message. In the given example texting device 14a is SIP-based. In the event of the non-SIP-based client 14b, emergency 9-1-1 text messages thereof must be translated before routing can be determined. In the exemplary scenarios, emergency 9-1-1 text messages generated by the SMS client 14c must also be translated before routing can be determined. SIP signaling is sent from the IM/SMS gateway 18 to a the national emergency VPC 16 for emergency routing determination and routing instruction completion. Preferably this includes a 10-digit number that determines the selective router 22 for the desired PSAP 20, and a 10-digit number that is recognized by selective router 22 as being properly routed to the PSAP 20 as determined by the VPC 16. The VPC 16 forwards emergency routing details via SIP to the emergency services Media Gateway 24 via the voice player 32. The emergency services Media Gateway 24 then sends a pANI to the selective router 22, in the given exemplary case, the 10-digit number that will be recognized by the selective router 22 as being properly routed to the PSAP 20 as determined by the VPC 16. The selective router 22 sends the digits to the PSAP 20 with a voice recording obtained from voice player 32 explaining that the emergency 9-1-1 service request is from a texting user. The PSAP 20 then queries the ALI 28 with the 10-digit number. The ALI 28 queries the national emergency VPC 16 and returns to the PSAP 20 the user's name, address, and return text address (preferably including a text format to be used, e.g., SMS or IM). The PSAP 20 establishes the appropriate text connectivity either between the client device 14a, 14b or 14c and the PSAP 20, or the relevant responsive text must be anchored on the IM/SMS Gateway 18 for communication with the user.

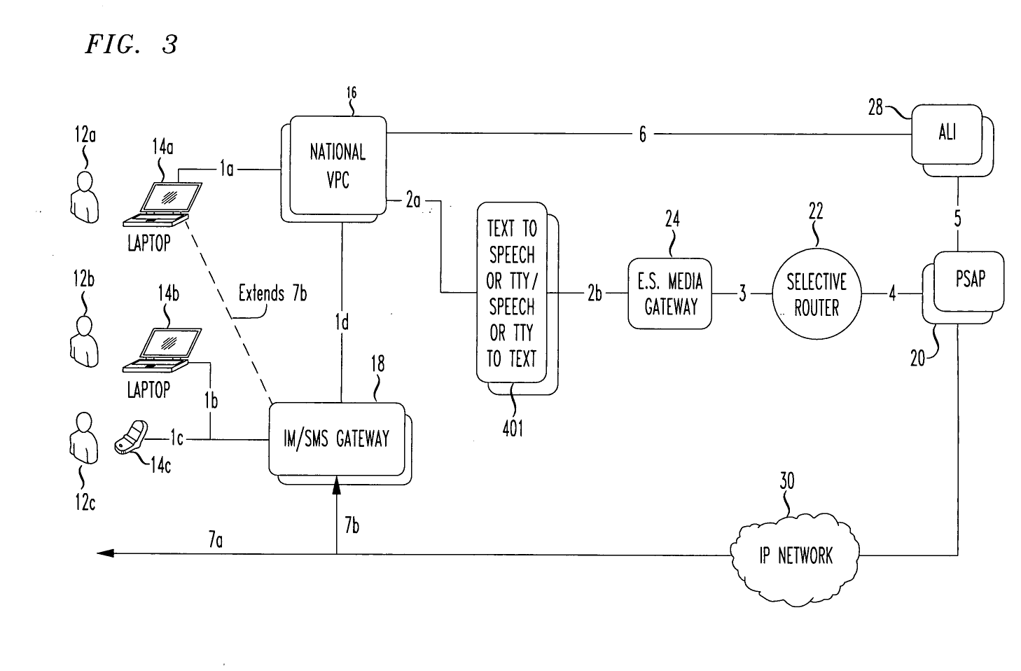

FIG. 3 shows an emergency 9-1-1 text messaging system wherein like reference numerals of other components in the system correspond to elements of the system shown in FIG. 1, but additionally including a text-speech translation device, in accordance with yet another aspect of the invention.

In the system of FIG. 3, a user initiates a request for emergency services via text-to-911 messaging. IM client 14a is SIP based. IM client 14b is not SIP based and messages transmitted thereby must be translated before routing can be determined. Messages transmitted by SMS client 14c must also be translated before routing can be determined. SIP signaling is sent from gateway 18 to VPC 16 for emergency routing determination and routing instruction completion. This includes a 10-digit number that determines the selective router 22 and a 10-digit number that is recognized by the selective router 22 as being properly routed to the PSAP 20 as determined by the VPC 16.

VPC 16 forwards emergency routing details via SIP to the Emergency Services Media Gateway 24 via the text-to-speech translation device 34. The Media Gateway 24 sends the pANI to the selective router. In this case, the 10-digit number recognized by the selective router 22 as being properly routed to the PSAP 20 determined by the VPC 16. The selective router 22 sends the digits with a voice recording explaining the emergency service request is from a text user to the PSAP and then converting the text message sent by the user into speech or TTY/TDD, which is generated by the text-to-speech device 34. Speech generated by a dispatcher at PSAP 20 may conversely be converted to text or the TTY/TDD typed by the dispatcher may be converted to an IM or SMS. It should be noted that the PSAP 20 would be able to see the text generated over an IP interface by the Speech-to-Text server 34. In order to do this, the text-to-speech server 34 may include a database of common SMS abbreviations or acronyms. The PSAP 20 queries the ALI 28 with the digits in order to return the user's name and address, as well as an IM address with a notice that a text only interface is also available. The PSAP 20 establishes IM connectivity via IM communication direct between the user and the PSAP, or alternatively, an SMS must be anchored and IM may be anchored on the IM/SMS Gateway.

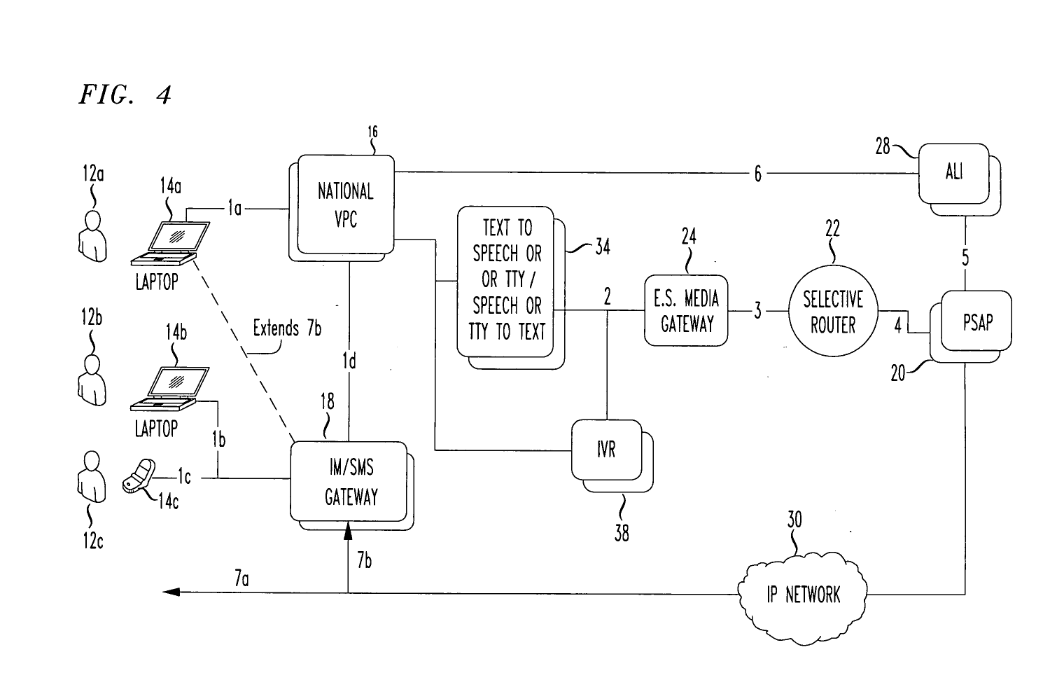

FIG. 4 shows a text-to-911 messaging system that additionally includes an interactive voice response (IVR) system 38 and a text-speech translation device 34 wherein like reference numerals of other components in the system correspond to elements of the system shown in FIG. 1. Here, a user initiates a text request for emergency services where IM client 14a is SIP-based. IM client 14b is not SIP-based and messages transmitted thereby must be translated before routing can be determined. Messages of SMS client 14c must also be translated before routing can be determined. SIP signaling is sent from gateway 18 to a VPC 16 for emergency routing determination and routing instruction completion. This includes a 10-digit number that determines the selective router 22 and a 10-digit number that is recognized by the selective router 22 as being properly routed to the PSAP 20 as determined by the VPC 16.

VPC 16 forwards emergency routing details via SIP to the Emergency Services Media Gateway 24. The Media Gateway 24 sends the pANI (pseudo automatic number identification) to the selective router 22. In this case, the 10-digit number is recognized by the selective router 22 as being properly routed to the PSAP 20 as determined by the VPC. The selective router 22 sends the digits with a voice recording explaining that the emergency service request is from a text user to the PSAP. A dispatcher situated at PSAP 20 can hear what was typed by the user. This is accomplished by a “Text to Speech” engine capability of system text-to-speech converter 34. A dispatcher situated at PSAP 20 is then able to communicate common requests, such as, please verify your location, describe the car, remain calm, etc. using DTMF tones that selects from memory the appropriate message via programmed options of the IVR system 38, and the system delivers corresponding text messages back to the user. To obtain location information, the PSAP 20 queries the ALI 28 with the digits. The ALI queries the VPC and returns the user's name and address, as well as an IM address with a note that a text interface is also available. The PSAP 20 optionally establishes IM connectivity directly between the user and the PSAP, or alternatively, the SMS must be anchored and IM may be anchored on the IM/SMS Gateway 22.

Another embodiment of the invention includes a non-emergency application in which a caller initiates a text communications request to the VPC and receives a response that includes a query in which the caller is asked to indicate the telephone number sought to be called, and to select from a menu of previously-created response options that are stored in memory. At the time of registration, or at any time thereafter, the subscriber may create as many customized response options as desired. The customized menu may include various options like “Pizza,” “Doctor,” “Restaurant,” “Auto,” etc. The subscriber may then create a list of responses for each option. For example, under the “Pizza” option the subscriber might create 1=“what is the delivery address?”; 2=“what size?”; 3=“what toppings?”; *1495=“that comes to $14.95.”

The subscriber then sends the desired number and the menu option and a message back to VPC. The VPC dials the number and provides a text-to-voice translation to the called party; e.g., “Hello, this is Joe Blow with a text communication: I would like to order a pizza. Press 1 for the delivery address. Press 2 to request the size. Press 3 to request the toppings. Press star 4 to send the price.” The VPC would then translate the DTMF tones entered by the called party into a text message and send it back to the caller. Using DTMF tones, the pizza establishment ascertains the order and delivers the pizza. Such a system would be particularly useful for hearing and/or speech impaired persons. The deaf may apply the invention in many other situations.

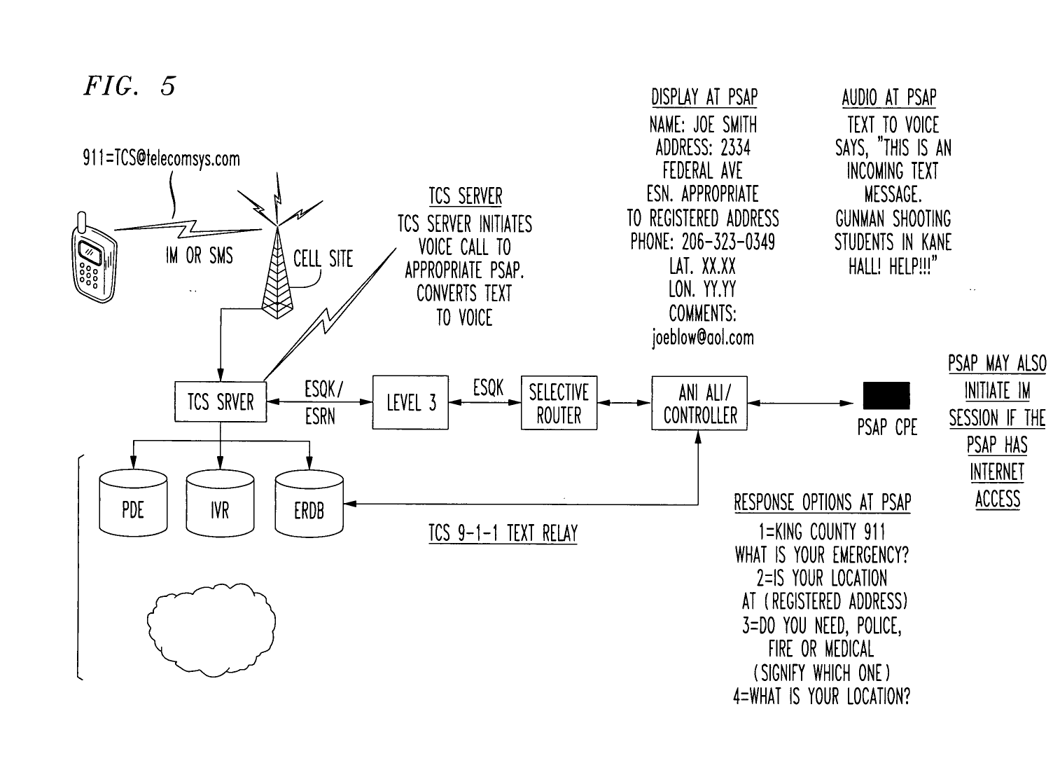

FIG. 5 shows a VPC 9-1-1 text relay system that may be situated at a network operations center (NOC) to provide (i) automatic call routing to correct PSAP, (ii) automatic location data in the ALI data, (iii) automatic IM/SMS address in ALI data, and (iv) optional DTMF canned or pre-programmed responses that may be created by user customization. Advantages include fast access to correct PSAP, no TTY headache or equipment required, works with SMS or IM (IM is more secure and is preferred by users), no upgrades to most PSAPs, works with existing handsets, location and call-back info in ALI data, no registration required (location data less reliable), usable by anyone including the deaf, and carrier agnostic (no carrier upgrades/provisioning required).

Features of the above-described embodiments may be combined in numerous ways to implement alternative systems without departing from the scope or intent of the invention. For instance, the voice recording can be combined with the IVR options and text to speech server. The solution provided herein will pave the way to eliminate obsolete equipment like TTY, which must be maintained at every PSAP, even as the potential users at home no longer have the equipment or knowledge to use it.

While the invention has been described with reference to the exemplary embodiments thereof, those skilled in the art will be able to make various modifications to the described embodiments of the invention without departing from the true spirit and scope of the invention.

What is claimed is:

1. A text-to-911 communication system enabling a text messaging caller to communicate with a called party on an emergency services voice network, comprising:
a physical communication server adapted to receive an emergency text message from an emergency text messaging caller;
a text-to-speech translator to convert said emergency text message to converted voice; and
a physical emergency services gateway adapted to pass said converted voice to a called party on a 911 emergency services voice network.

2. The text-to-911 communication system enabling a text messaging caller to communicate with a called party on an emergency services voice network according to claim 1, further comprising:
a speech-to-text translator to convert voice from said called party into a text message.

3. The text-to-911 communication system enabling a text messaging caller to communicate with a called party on an emergency services voice network according to claim 2, further comprising:
a location database to store location information relating to said emergency text messaging caller;
wherein said physical communication server effects transmission of a location of said emergency text messaging caller to be accessible by said called party when sending said emergency text message to said called party.

4. The text-to-911 communication system enabling a text messaging caller to communicate with a called party on an emergency services voice network according to claim 3, further comprising:
a speech-to-text translator to convert voice from said called party into a return text message.

5. The text-to-911 communication system enabling a text messaging caller to communicate with a called party on an emergency services voice network according to claim 4, further including a speech-to-text wherein:
said speech-to-text translator forwards said return text message back to said emergency text messaging caller.

6. The text-to-911 communication system enabling a text messaging caller to communicate with a called party on an emergency services voice network according to claim 1, further comprising:
an IM/SMS gateway to provide short messaging and instant messaging services to said emergency text messaging caller.

7. A method of enabling an emergency text messaging caller to communicate with a called party on an emergency services network, comprising:
receiving an emergency text message from an emergency text messaging caller;
obtaining a street address of said emergency text messaging caller from a database including pre-registered location information relating to said caller;
converting the received emergency text message to an emergency converted voice message; and
routing said emergency converted voice message to the called party, said emergency converted voice message including said obtained pre-registered location information relating to said emergency text messaging caller.

8. The method of enabling an emergency text messaging caller to communicate with a called party on an emergency services network according to claim 7, further comprising:
receiving a return voice message from said called party;
converting said return voice message to a return text message; and
routing said return text message back to said emergency text messaging caller.

9. A method of enabling an emergency text messaging caller to communicate with a called party situated on an emergency services network, comprising:
providing in physical memory a set of pre-programmed voice responses;
prompting said emergency text messaging caller to select at least one of said pre-programmed voice responses,
obtaining a location of said emergency text messaging caller from a database including pre-registered location information relating to said caller; and
routing said emergency converted voice message to the called party, said emergency converted voice message including said obtained pre-registered location information relating to said emergency text messaging caller.
